(19) United States
(12) Patent Application Publication
(10) Pub. No.: US 2004/0187075 A1
(43) Pub. Date: Sep. 23, 2004

(54) Document management apparatus, system and method

(76) Inventors: Jason G. Maxham, San Francisco, CA (US); Andrew M. Jenks, San Francisco, CA (US); Matthew K. Work, San Francisco, CA (US); J. Leslie Brennan, San Francisco, CA (US)

Correspondence Address: MCDERMOTT, WILL & EMERY, 600 13th Street, N.W., Washington, DC, 20005-3096, US

(21) Appl. No.: 10/752,432

(22) Filed: Jan. 7, 2004

Related U.S. Application Data
(60) Provisional application No. 60/438,508, filed on Jan. 8, 2003.

(51) Int. Cl. G06F 17/00

(52) U.S. Cl. 715/511

(57) ABSTRACT

The concepts herein address a novel document management system including a cluster computer arrangement in which native documents may be stored substantially equally amongst each node. Also disclosed are methods for performing a search based on user-defined search criteria, as well as user-defined classifications that may be applied to documents represented by the search results.

### RELATED APPLICATIONS

This application claims priority from Provisional Application Serial No. 60/438,508 filed on Jan. 8, 2003, entitled: “ELECTRONIC DOCUMENT MANAGEMENT”, the entire disclosure of which is hereby incorporated by reference herein.

### FIELD OF THE INVENTION

The invention relates to an apparatus and method for storing, searching, retrieving, and delivering electronic documents, and a program product for implementing the same, for the purpose of managing a multiplicity of documents.

### BACKGROUND

Many of today's businesses employ sophisticated document management systems for managing existing electronic documents. Despite this, there has not been developed a document management system for providing management services to both existing electronic documents and paper documents. Of particular importance is the need to provide an effective search tool for documents, for example, produced during litigation. Current products on the market permit users to scan paper-based documents or convert electronic documents to a standard format, such as TIFF. However, conversion of tremendous amounts of documents can be time consuming, and expensive. Moreover, document conversion does not reliably maintain all information in a respective document across the many types of file types that may be examined.

Also, in court litigation and regulatory proceedings, prior electronic document management structures and methods to store, search, retrieve and deliver electronic documents generally require a constrained format to accomplish the necessary functions to achieve effective electronic document management. This is particularly the case in litigation matters where a party before a court needs to organize a multiplicity of documents into a manageable electronic document system. In such litigation, the documents take a variety of formats and structures ranging from letters to detailed reports so that a rigid format may not provide the accessibility and precise recall of critical information for litigation.

A document management system is needed to alleviate the above mentioned problems.

### SUMMARY

The concepts disclosed herein alleviate the above noted problems.

More particularly, a method for managing a plurality of native documents to be uploaded to a document management computer system, includes determining a file type for each native document of the plurality of native documents, creating a fingerprint for each native document, de-duplicating each native document in accordance with the fingerprint, extracting data from each native document, associating extracted data with a corresponding native document, and distributing the plurality of native documents and extracted data substantially equally amongst a plurality of nodes of the document management computer system. By distributing native documents and extracted data substantially equally amongst the nodes, search processing time may be reduced.

Another novel aspect includes a method for searching a plurality of native documents stored in a document management computer system having a plurality of computer nodes storing the plurality of native documents. The steps include defining search criteria for searching the plurality of native documents, executing in parallel searches in accordance with the search criteria for each computer cluster of the plurality of nodes, wherein each computer cluster scores each search result in accordance with the search criteria, ranking the search results in accordance with the score determined in each computer cluster, omitting certain documents represented by the search results in accordance with a user's predefined permission level, and displaying final search results to a user. As a result, depending on a user's predefined permission level may protect documents that should not be viewed by the user conducting the search.

In yet another novel aspect, disclosed is a method for managing attributes of at least one native document produced from a search of a plurality of native documents stored in a document management computer system. The steps include defining search criteria for searching the plurality of native documents, executing a search in accordance with the defined search criteria, displaying search results, and modifying document attributes of at least one document represented by the search results, and storing modified document attributes associated with the at least one document, wherein the modified document attributes are maintained for future searches. As a result, a user may apply a user-defined classification to be displayed when the corresponding document(s) is subsequently viewed.

In even yet another novel aspect, a method is disclosed for searching a plurality of native documents stored in a document management computer system. The steps include defining search criteria for searching the plurality of native documents, executing a search in accordance with the defined search criteria, displaying search results as links to data files representative of associated native documents, and selectively viewing a native document represented by at least one link of the search results displayed to the user. Accordingly, because information may be lost when the native document is converted to a data file, the native document nevertheless may be viewed for its original format.

Other novel aspects include a method for producing search results of a plurality of native documents stored in a computer system in accordance with a user-defined search query. There is provided at least one server in communication with the computer system for storing the plurality of native documents to be searched. The server receives the user-defined search query, and sends a search query to the computer system in accordance with the user-defined search query. Search results are received from the computer system corresponding to the user-defined search query. Therefore, by attributing at least one user defined classification to at least one document represented by the search results received, the user defined classification is displayed when the at least one document is later viewed.

Moreover, there is disclosed a method for producing search results of a plurality of native documents stored in a computer system in accordance with a user-defined search query. There is provided a Website hosted by a server that interfaces with the computer system and a user connected via a user interface over a communication network. Under control of the user interface, search results of the plurality of native documents are displayed in accordance with the user-defined search query. In response to at least one user-defined classification selected by the user, the user-defined classification is attributed to at least one native document represented by the search results. Thus, the user-defined attribute is displayed when the link representing the at least one native document is later viewed.

In still another novel aspect, an electronic document management system is disclosed. It includes a plurality of computer nodes for storing a plurality of native documents, and a computer in communication with the plurality of computer nodes for receiving a plurality of input files to be uploaded to the plurality of computer nodes. The computer is configured to determine the type of native document for each of the plurality of input files, to assign a unique identification tag to each native document, and to eliminate duplicate native documents based on the unique identification tags, for producing a subset of input files to be uploaded to the plurality of computer nodes. Also, the subset of input files are distributed substantially equally amongst the plurality of computer nodes.

In yet another novel aspect, an electronic document management system comprising a PC type computer connected in a parallel cluster, said computer using an operating system that stores electronic documents in a hard disk drive throughout the cluster, said operating system defining a document identification tag where each document is identified by its files extension that is converted to ASCII text and given a unique identification number, each of a plurality of documents having at least one of either meta-data, text or attachments identified for retrieval that are indexed for web-based retrieval from the cluster database, said identification of the plurality of documents forming a cluster data base that is web-searchable by use of a predetermined descriptive term.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic diagram of a computer system used to implement the disclosed concepts.

FIG. 2 illustrates a system for managing a plurality of documents to be loaded in the computer system of FIG. 1.

FIG. 3 illustrates a flow diagram of a search to be implemented by the computer system of FIG. 1.

FIG. 4 illustrates an exemplary webpage in which search criteria may be entered.

FIG. 5 illustrates another exemplary webpage.

FIGS. 6a-c illustrates pull-down menus of an exemplary webpage.

FIG. 7 illustrates a flow diagram of a user initiated search.

FIG. 8 illustrates an exemplary webpage and a search to be conducted.

FIG. 9 illustrates an exemplary webpage displaying search results in accordance with the search criteria entered in the webpage of FIG. 8.

FIGS. 10a-b illustrates a document selected from results of a search.

FIG. 11 illustrates a flow diagram of various user-defined classification that may be applied to document(s) represented from a search.

### DESCRIPTION

Management of large amounts of documents may require a sophisticated computer system. While a PC or server may be used to manage a relatively small set of documents, storage and computing capacity becomes a major limitation when managing a large set of documents, especially if enhanced searching capabilities are implemented. In accordance with the novel concepts discussed herein, electronic documents may be maintained by a computer cluster. Computer systems of this nature are easily scalable, allowing the addition of new nodes including one or more computer clusters when more storage capacity and computing power is needed. Also, these types of computing systems are redundant. If a cluster fails, the computer system remains functional. Other advantages of cluster computing will be discussed further herein.

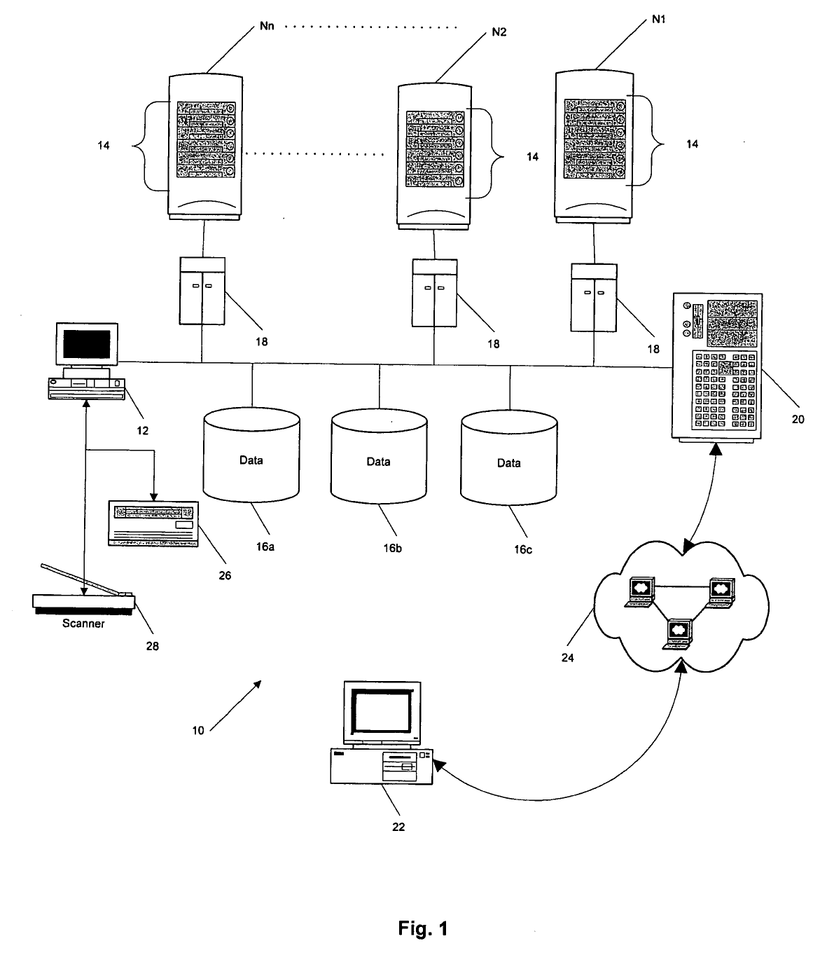

FIG. 1 illustrates an example of a computer system 10 in a cluster arrangement. The hardware of computer 12, computer 22, server 20, processor 18 and RAID-5 arrays N1-Nn, each of which are connected to the computer system 10, are general purpose in nature, albeit with an appropriate network connection for communication via an intranet, the internet and/or other data networks. As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes.

RAID-5 arrays may be best suited for storing and managing a multiplicity of documents for at least one client. While the computer system 10 may include only one RAID-5 disk array, FIG. 1 illustrates the computer system 10 with one or more RAID-5 disk arrays, node N1-node Nn, each of which includes a plurality of disk drives 14. In the alternative, each node N1-Nn may be a single disk drive 14 or a grouping of disk drives 14 from one or more nodes N1-Nn. Databases 16a-c may also be connected to the computer system 10. Other types of devices may be included in the computer system 10 that are not specifically shown in FIG. 1. The diversity of data storage devices used in data storage management systems lends itself to different user designs, specifications and customization. The computer system 10 illustrated by FIG. 1 shall not be limiting to the concepts discussed herein.

Computer 12 and processor 18 may employ a Linux operating system, an open source code operating system. Processors 18 are connected to RAID-5 arrays, nodes N1-Nn, in a parallel manner, and each controls a respective RAID array. The total combined processing speed may be increased to super-computing levels by increasing the number of processors 18. Software operating on each node, N1-Nn, functions in such a manner that each hard disk drive 14 processes information as if it were part of a single large disk drive, and each computer processor functions as if it were a single processor. As a result, any data that may be lost due to malfunction of any one computer disk is automatically recovered by the other disks 14 of the raid array.

The software functionalities of the computer system 10 involve programming, including executable code. The software code is executable by the general-purpose computer, explained above. In operation, the code and possibly the associated data records are stored within the general-purpose computer platform. At other times, however, the software may be stored at other locations and/or transported for loading into the appropriate general-purpose computer systems. Hence, the embodiments discussed further herein involve one or more software products in the form of one or more modules of code carried by at least one machine-readable medium. Execution of such code by a processor of the computer system 10 enables the platform to implement the catalog and/or software downloading functions, in essentially the manner performed in the embodiments discussed and illustrated herein.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s) operating as one of the server platform, discussed above. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, less commonly used media such as punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Referring again to FIG. 1, the computer system 10 may be accessible by an administrator via a stand-alone work station represented by computer 12. An internet server 20 interfaces with the computer system 10 to permit end-user access the system via the internet 24 through at least one user terminal 22.

The computer system 10 is configured to manage large sets of documents for multiple clients, but limits user access to documents supplied by the associated client. Documents supplied by a client are uploaded to the computer system 10 using work station 12. Documents may be supplied in electronic form or in hard copy form. If in electronic form, a suitable drive 26 corresponding to the medium type is used to upload electronic documents to the computer system 10. Also, if documents are in hard copy, they may be scanned using scanner 28 and uploaded to the computer system 10.

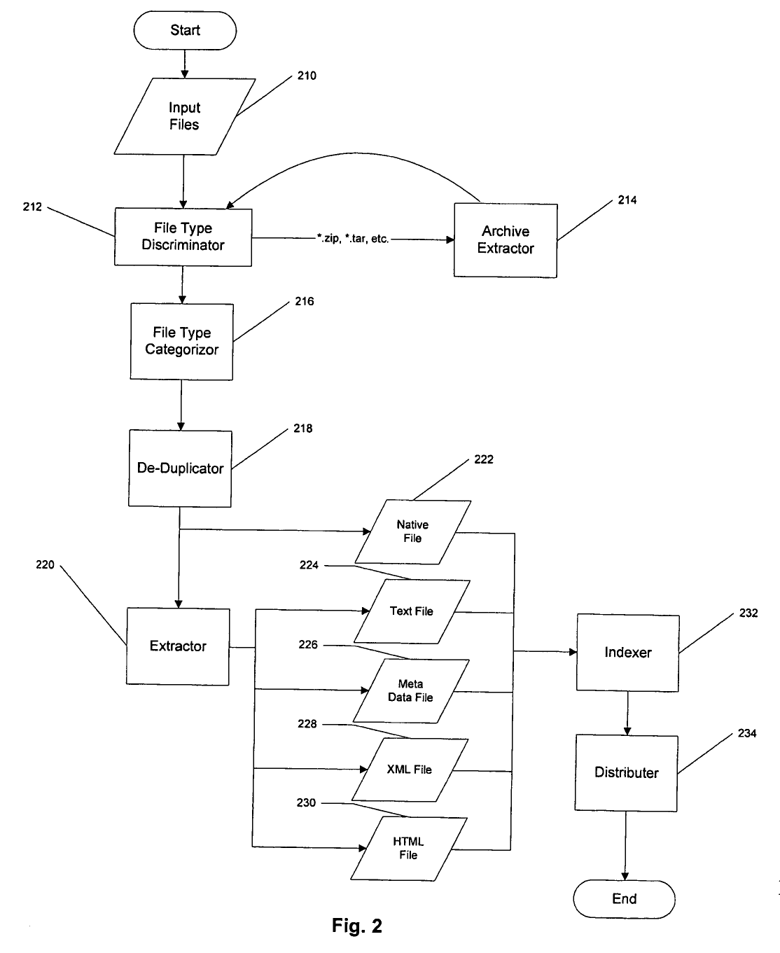

FIG. 2 illustrates a system for managing documents uploaded to the computer system 10. First, data is loaded into the computer system 10 via workstation 12. Next, the file type discriminator 212 determines file types based on the file extension of each input file 210. If the file type is an archive, such as .zip, .tar, etc., archive extractor 214 extracts archived file(s). Again, the file type of the extracted documents are determined by the file type discriminator 212.

Often clients periodically upload documents to the computer system 10 and provide large document sets to be uploaded at any one time. As a result, duplicate documents may be stored in the computer system 10. Also, duplicate documents may exist amongst the documents to be uploaded. Before distributing input files 210 in the computer system 10, file categorizer 216 creates a fingerprint of each file. Well known cryptographic algorithms, such as the MD5 checksum, may be used to create a fingerprint unique to each file. In accordance with the fingerprint, each document is de-duplicated. More particularly, de-duplicator 218 compares the fingerprint of each input file 210 with other fingerprints corresponding to the other input files 210, and compares with the fingerprints of documents already stored in the computer system 10. If a match is found, the document to be uploaded is discarded, so as to prevent multiple documents from residing in the computer system 10.

After the documents to be uploaded have been de-duplicated, extractor 220 converts each native document 222 (corresponding to the input files 210 in original format) to at least a text file 224. Other files that may be generated include meta data files 226, XML files 228, and HTML files 230. Well known third party software packages may be used in this conversion process.

Indexer 232 creates a file association table for each native document that maintains the associations between each native document 222, converted documents 224-230, and attachments, if any, to the native document. These attachments commonly referred to as “children files.” While the file association table may be stored in any of the nodes N1-Nn, other databases 16a-c may be used to maintain file association tables. Distributor 234 distributes native documents and converted documents substantially equally amongst the nodes of the computer system 10, after which time, the documents may be searched.

Referring back to FIG. 1, a three cluster arrangement is shown. In this example, about a third of the documents to be uploaded would be distributed to each node N1-Nn of the computer system 10. Each processor 18 interfacing within each node Nn executes a search daemon for searching files in each node. Therefore, when a search is initiated by server 20, multiple processors 18 execute the search in parallel. The search daemon scores each document based on search criteria specified. Results from each search daemon can be compared against results from other search daemons. For example, Table 1 provides an example of search results produced by each search daemon.

TABLE 1

| | Node N1 Results | Node N2 Results | Node N3 Results |
|---|---|---|---|
| Search Results | Scoring | Scoring | Scoring |
| Document 1 | 0.96 | 0.99 | 0.95 |
| Document 2 | 0.82 | 0.80 | 0.93 |
| Document 3 | 0.76 | 0.45 | 0.77 |
| Document 4 | 0.50 | N/A | 0.39 |
| Document 5 | 0.49 | N/A | 0.25 |

Server 20 receives search results from each processor 18 and merges the search results accordingly. Assuming that only the top five search results were requested, the search results may be compiled in the following manner.

TABLE 2

| Main Results | Location | Score |
|---|---|---|
| 1. | Document 1, Node N2 | 0.99 |
| 2. | Document 1, Node N1 | 0.96 |
| 3. | Document 1, Node N3 | 0.95 |
| 4. | Document 2, Node N3 | 0.93 |
| 5. | Document 2, Node N1 | 0.82 |

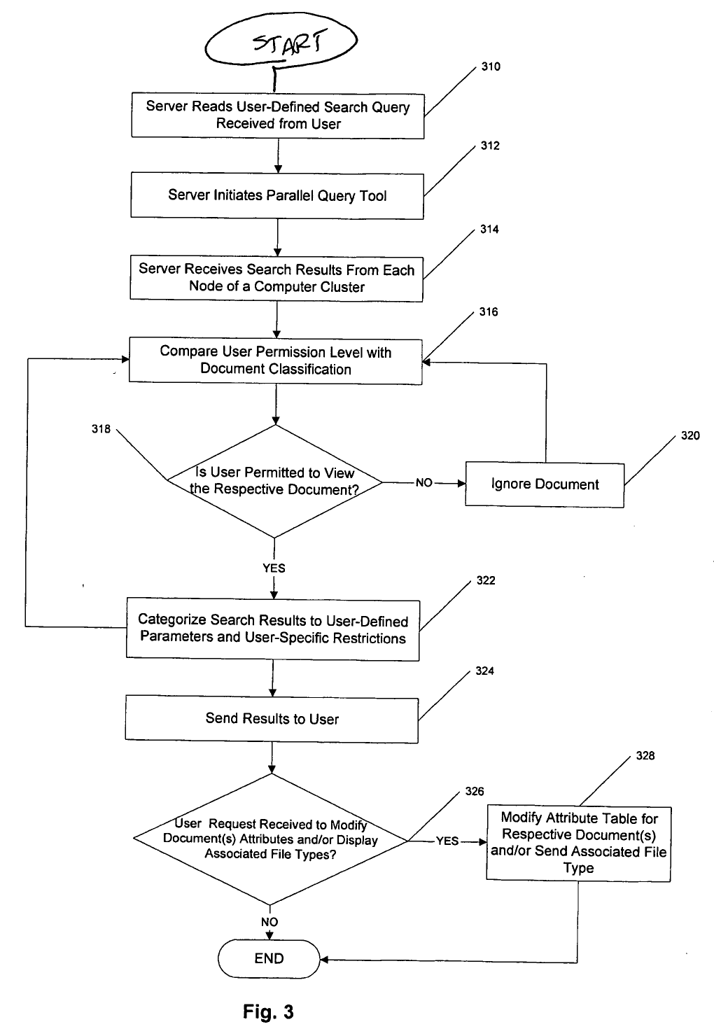

In more detail, FIG. 3 illustrates a flow diagram of the search process initiated by server 20. First, in Step 310, server 20 receives a search query from a user via a user interface 22 over the internet 24. In Step 312, server 20 initiates the parallel query tool, i.e., server 20 causes each processor 18 to execute respective search queries in accordance with the search criteria received by server 20. In Step 314, server 20 receives the search results from each processor 18 of each cluster, e.g., as shown in Table 1.

Users accessing the computer system may have pre-defined permission levels, e.g., on a scale of 1 to 5; 1 being the lowest level and 5 being the highest. Also, documents classifications may be assigned to each document on the same scale. Therefore, only documents that have a document classification equal to or less than the user's pre-defined permission level may be viewed by the user. This allows one to restrict access to certain documents, especially those that are highly confidential. Table 3 provides an example of search results identical to those of Table 1, but with document classifications for each document.

| | Node N1 Results | Node N2 Results | Node N3 Results |
|---|---|---|---|
| | Scoring and (Doc. | Scoring and (Doc. | Scoring and (Doc. |
| Search Results | Classification) | Classification) | Classification) |
| Document 1 | 0.96 (3) | 0.99 (5) | 0.95 (4) |
| Document 2 | 0.82 (1) | 0.80 (5) | 0.93 (3) |
| Document 3 | 0.76 (2) | 0.45 (2) | 0.77 (3) |
| Document 4 | 0.50 (5) | N/A | 0.39 (1) |
| Document 5 | 0.49 (4) | N/A | 0.25 (4) |

In Step 316, server 20 compares each document classification with the user's predefined permission level, and in step 318 determines whether or not the user is permitted to view the document. If the user is restricted from reviewing a respective document, the document is ignored, Step 320. Conversely, if the user is permitted to view the document, the search result is categorized, in step 322. Steps 316-322 are repeated until the document classification for each document is compared against the user permission level.

Assuming that a user has a permission level of 3, Table 4 lists search results compiled by server 20 in accordance with comparison with document classifications. Comparison with Table 2, discussed above, reveals starkly different search results due to the pre-defined user permission level. The italicized search results shown in Table 3 identifies the documents that would be ignored in Step 320 because of user permission level.

TABLE 4

| Main Results | Location | Score |
|---|---|---|
| 1. | Document 1, Node N1 | 0.96 (3) |
| 2. | Document 1, Node N1 | 0.93 (2) |
| 3. | Document 1, Node N3 | 0.82 (1) |
| 4. | Document 2, Node N3 | 0.77 (3) |
| 5. | Document 2, Node N1 | 0.76 (2) |

Conversely, Table 2 provides an example of the search results that would be sent to a user with a permission level 5 in Step 324.

Described in more detail below, in Step 326, a user may request to modify document attributes or display associated file types. In Step 328, if received, an attribute table is modified accordingly and/or the associated file type, e.g. a native document, may be sent to the user. The attribute table may be created by the file type categorizer 216 of FIG. 2 when uploading native documents. In the alternative, the attribute table may be created when an attribute is first modified. Attribute tables may be stored in databases 16a-c or Raid arrays N1-Nn.

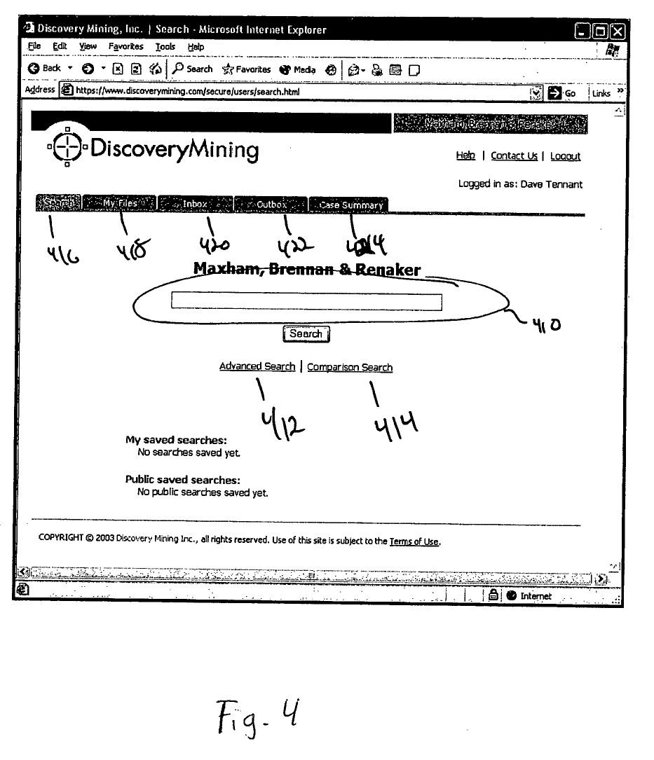

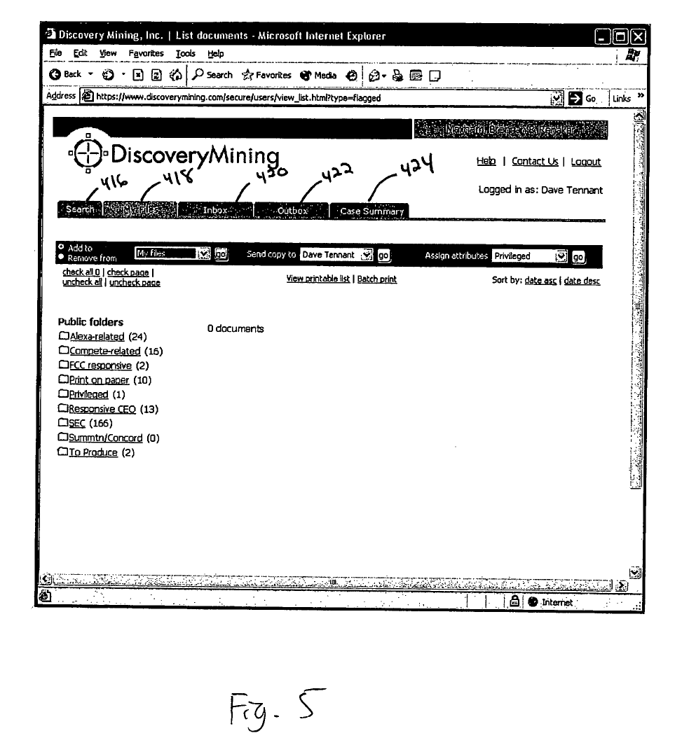

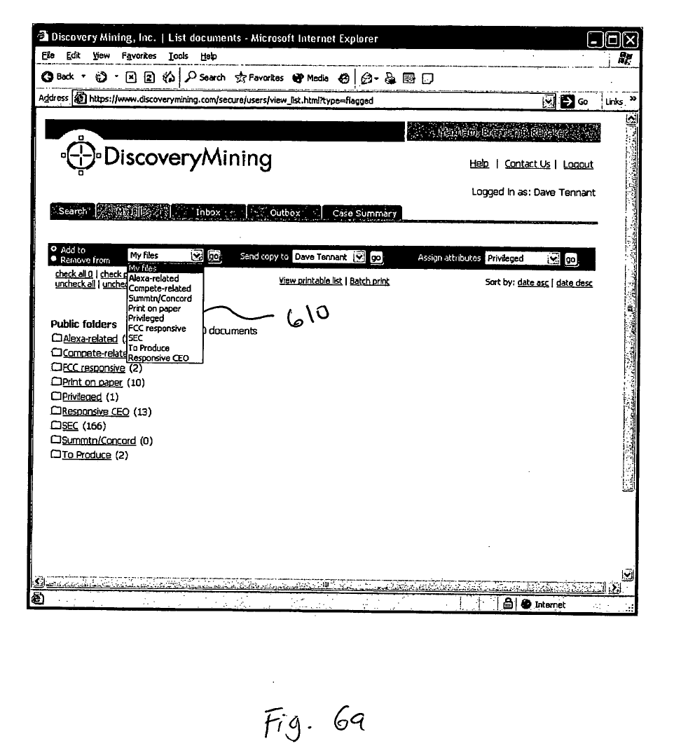

FIG. 4 illustrates a webpage displayed on a user interface 22 once a user has logged onto the computer system 10 via the internet 24 and server 20. The webpage includes field 410, in which the user may enter search criteria for initiating a search. Also provided are links to an advanced search 412 and comparison search 414 for different types of searches. Regardless of the page in which the user links, numerous tabs may always be displayed and may include a Search tab 416, My Files tab 418, Inbox 420, Outbox 422 and Case Summaries 424.

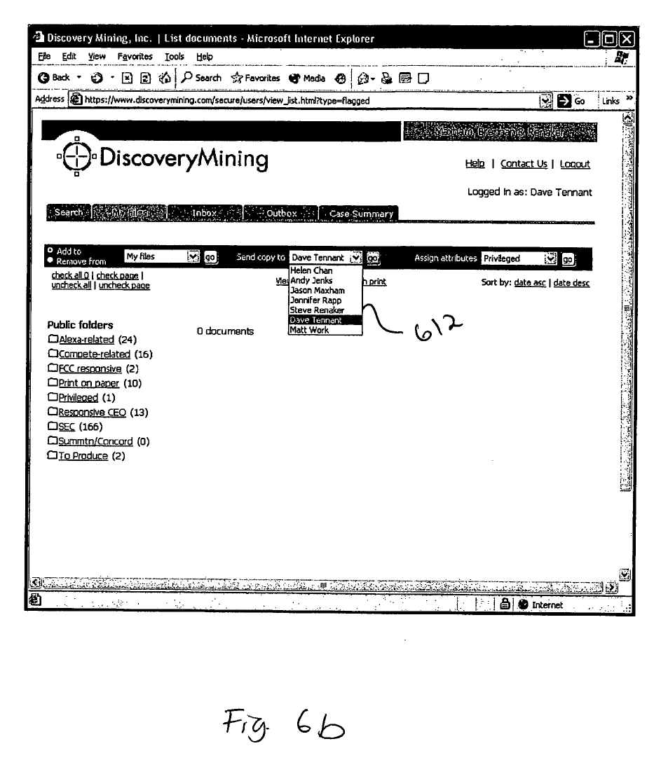

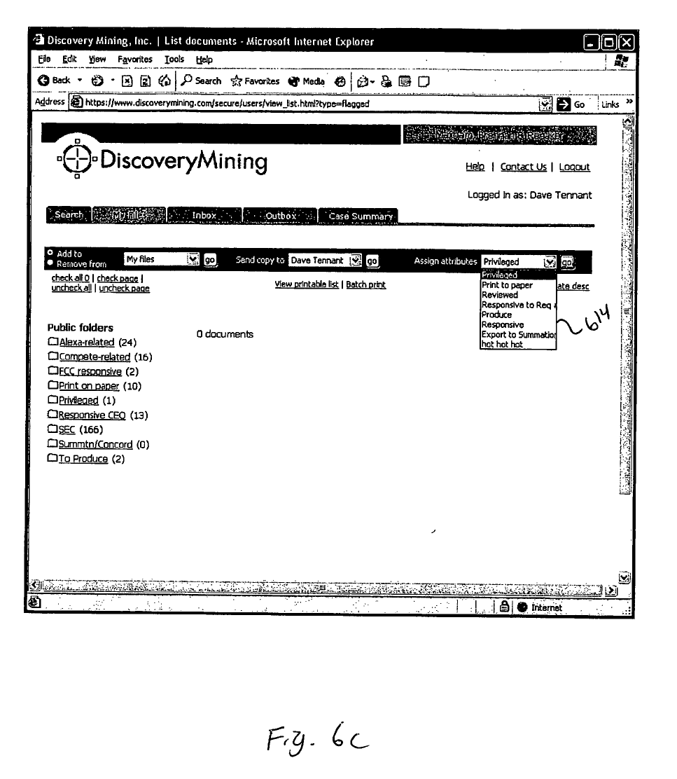

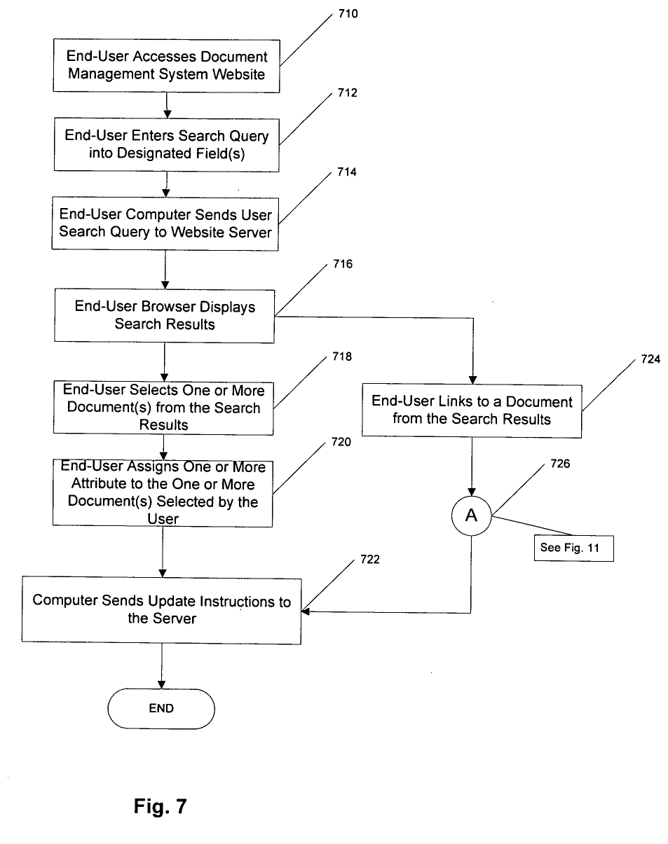

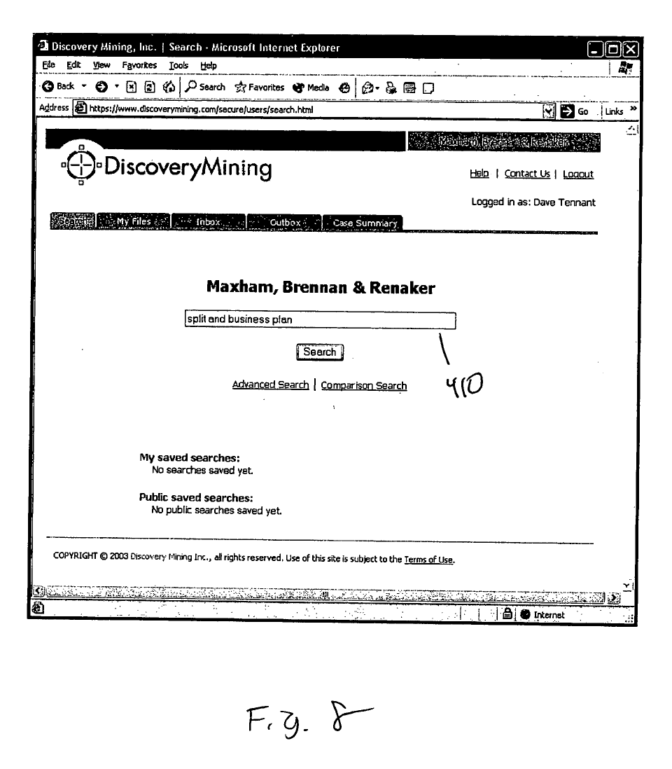

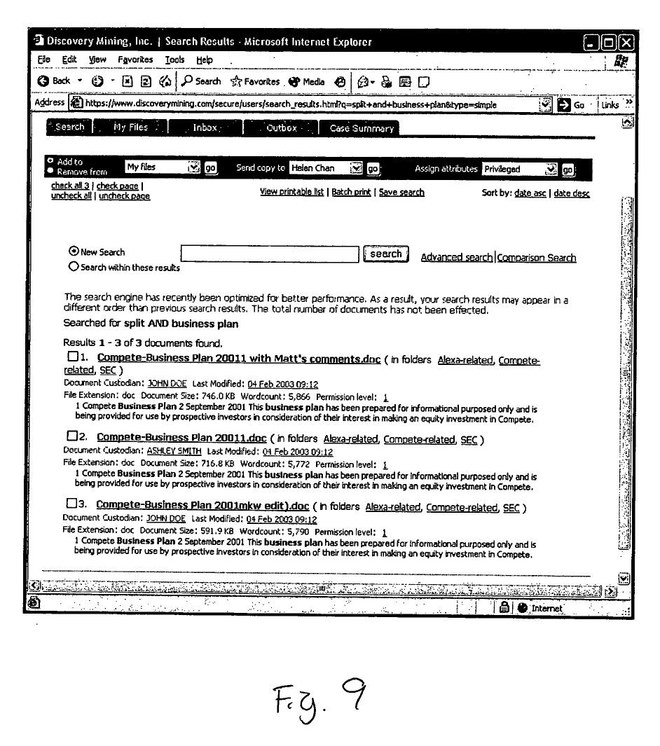

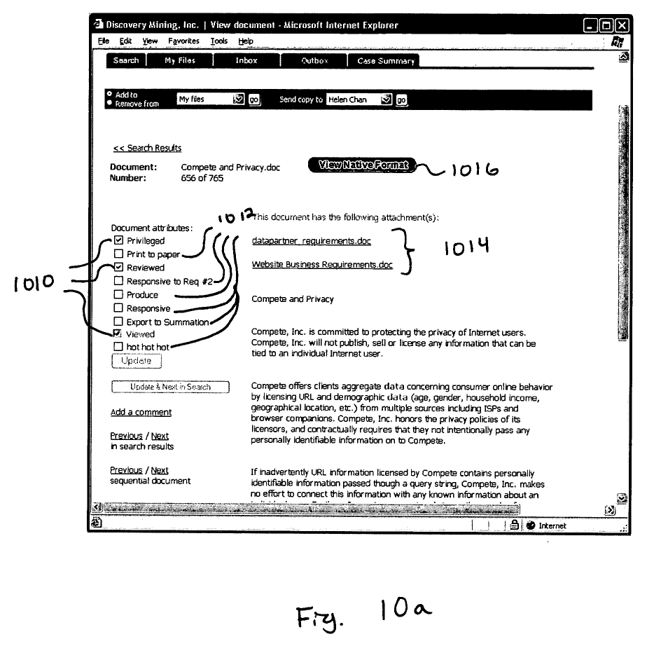

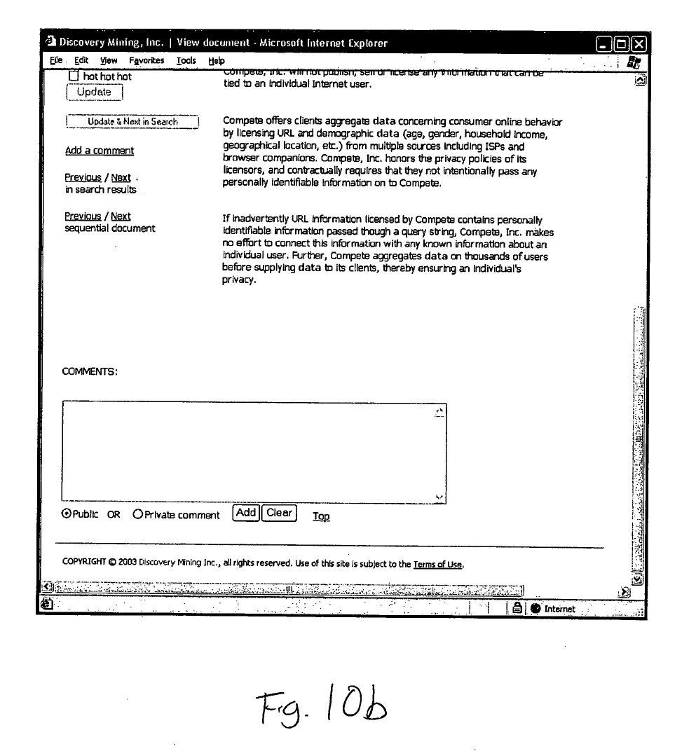

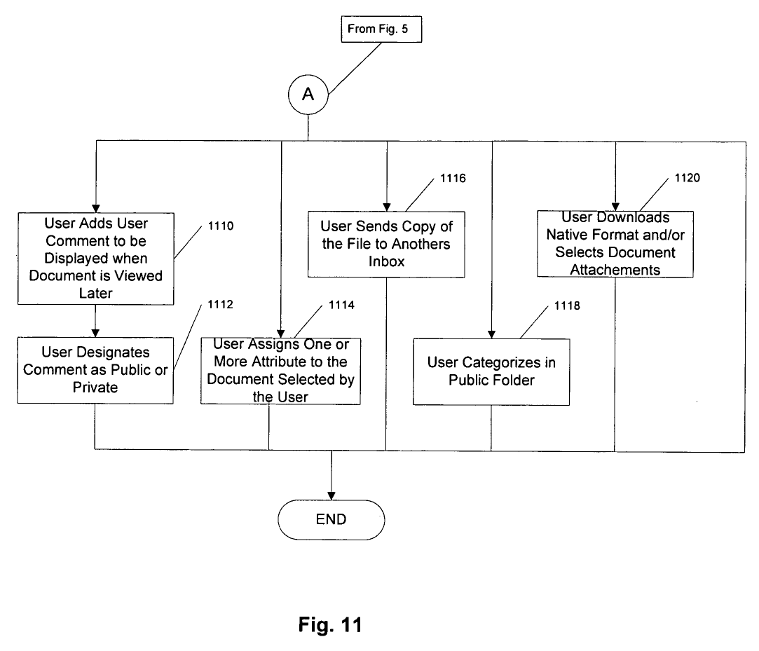

FIG. 5 illustrates an example of a webpage displayed when the My Files tab 418 has been selected. As shown, both user-associated files, as well as files categorized in public folders.

Three pull down menus are available, and permit various user actions on selected documents. FIG. 6a illustrates criteria specified in the “My Files” pull down menu 610. Here, document(s) may be associated with public folders. FIG. 6b shows selections for “Send copy to” pull down menu 612. Here, various users are listed. By selecting another user, a link to the document will be sent to the other user's inbox for future viewing. FIG. 6c shows the attribute menu. Here, various attributes may be assigned to documents selected.

FIG. 7 illustrates a flow chart of a search from the end-user perspective. In Step 710, an end-user accesses the document management website, and downloads to a browser the webpage such as shown in FIG. 4. In Step 712, a end-user enters search criteria in field 410, and in Step 714, search criteria is sent by the end-user interface 22 to server 20. Upon executing the query, server 20 produces search results in accordance with Steps 310-324 of FIG. 3 described above. In Step 716, the search results are displayed to the end-user. As mentioned in connection with FIGS. 6a-c, the end-user has various options for categorizing, forwarding, or assigning an attribute to each document produced from the search. The end-user may select one or more documents from the search results (Step 718), and categorize the selected documents from the pull-down menu illustrated in FIG. 6a. Also, the end-user may send selected documents to another end-user's inbox for future viewing, by selecting a end-user from the pull-down menu illustrated in FIG. 6b. Moreover, the end-user may assign one or more attributes to the selected documents from the pull-down menu illustrated in FIG. 6c. In this manner, the end-user need not select individual documents for each modification. End-user actions at least represented by FIGS. 6a-6c are each generally referred to as “user defined classification.”

For example, FIG. 8 provides an example of search for documents concerning “split and business plan,” entered by a end-user in the search criteria field 410. This search would be implemented in accordance with steps 710-714 of FIG. 7. FIG. 9 illustrates the search results displayed to the user in accordance with Step 716 of FIG. 7, and in accordance with Steps 310-324 of FIG. 3. Three links are displayed. Instead of selecting the documents individually, a user may check one or more of the documents, and categorize, send a copy to another user, and/or assign attributes to the one or more checked documents using the pull-down menus. This is a highly effective way to manage large sets of documents without the need to view each individual document.

If more information is needed for any particular document, a user may link to a document by selecting an associated link. FIGS. 10a-b illustrate a document entitled “Compete and Privacy.doc” selected from a search. When a user selects the document, the converted text, html, or xml file is displayed.

FIG. 11 a flow chart for attributing a user defined classification. More particularly, the user may add a comment (Step 1110) to be displayed when the document is later viewed. Also, the user may designate the comment as either public or private, so that it may be viewed by all users associated with the respective account, or only by the user entering the comment, respectively (Step 1112). Also shown are the attributes already assigned to the document, 1010. In Step 1114, the user may modify already assigned attributes 1010 or designate new attributes 1012. The user may send a link to the selected document to ones inbox using the “Send copy to” pull-down menu. Also, the user may categorize the selected document using the “My Files” pull-down menu.

Also displayed are links 1014 to children files, i.e., files that were attached to the native document 1016, which the user may select. Even yet another novel characteristics is the ability to retrieve the native document 1016, i.e., the document in its original format. The user need only click on the “View Native Format” button 1016, and at this time, the native format is downloaded to the user's computer. For security and integrity, the user may not upload the copy downloaded.

The attribute table discussed above may be updated with user defined classifications. Subsequent searches and document retrieval will identify user defined classifications previously designated. As a result, large sets of documents may be searched and classified accordingly. In this manner, the need to repeatedly review each and every document, during a litigation, can be limited.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A method for managing a plurality of native documents to be uploaded to a document management computer system, the steps comprising:
a) determining a file type for each native document of the plurality of native documents;
b) creating a fingerprint for each native document;
c) de-duplicating each native document in accordance with the fingerprint;
d) extracting data from each native document;
e) associating extracted data with a corresponding native document; and
f) distributing the plurality of native documents and extracted data substantially equally amongst a plurality of nodes of the document management computer system.

2. The method for managing the plurality of native documents according to claim 1, further comprising the step of extracting native document(s) included in the plurality of documents from an archive file.

3. The method for managing the plurality of native documents according to claim 1, wherein the fingerprint for each native document is created using a MD5 checksum.

4. The method for managing the plurality of native documents according to claim 1, wherein step (c) further comprises comparing the fingerprint of each native document with a plurality of fingerprints comprised of the fingerprints for each native document to be uploaded.

5. The method for managing the plurality of native documents according to claim 1, wherein step (c) further comprises comparing the fingerprint of each native document with at least one fingerprint corresponding to a native document stored in the document management computer system.

6. The method for managing the plurality of native documents according to claim 4, further comprising discarding native documents that are determined to be the same in accordance with the comparison of fingerprints.

7. The method for managing the plurality of native documents according to claim 5, further comprising discarding native documents that are determined to be the same in accordance with the comparison of fingerprints.

8. The method for managing the plurality of native documents according to claim 1, wherein step (d) further comprises creating at least one data file corresponding to the extracted data for each native document.

9. The method for managing the plurality of native documents according to claim 1, wherein step (d) further comprises creating a plurality of data files corresponding to the extracted data for each native document.

10. The method for managing the plurality of native documents according to claim 9, wherein the plurality of data files includes files selected from a group consisting of a text file, a meta data file, an XML file and a HTML file.

11. The method for managing the plurality of native documents according to claim 10, wherein in step (e), a data table is created for at least one native document for defining an association with the plurality of data files.

12. The method for managing the plurality of native documents according to claim 1, wherein in step (e), a data table is created for at least one native document for defining an association with extracted data.

13. A program product, comprising executable code transportable by at least one machine readable medium, wherein execution of the code by at least one programmable computer causes the at least one programmable computer to perform a sequence of steps, comprising the steps recited in claim 1.

14. A method for searching a plurality of native documents stored in a document management computer system having a plurality of computer nodes storing the plurality of native documents, the steps comprising:
a) defining search criteria for searching the plurality of native documents;
b) executing in parallel searches in accordance with the search criteria for each of the plurality of nodes, wherein each computer node scores each search result in accordance with the search criteria;
c) ranking the search results in accordance with the score determined in each computer node; and
d) omitting certain documents represented by the search results in accordance with a user's predefined permission level; and
e) displaying final search results to a user.

15. The method for searching a plurality of native documents according to claim 14, further comprising comparing the user's predefined permission level with a document classification for each native document represented by the search results.

16. The method for searching a plurality of native documents according to claim 15, further comprising determining whether or not a user is permitted to view each native document represented by the search results in accordance with the comparison of the user's predefined classification and the document classifications.

17. A program product, comprising executable code transportable by at least one machine readable medium, wherein execution of the code by at least one programmable computer causes the at least one programmable computer to perform a sequence of steps, comprising the steps recited by claim 14.

18. A method for managing attributes of at least one native document produced from a search of a plurality of native documents stored in a document management computer system, the steps comprising:
a) defining search criteria for searching the plurality of native documents;
b) executing a search in accordance with the defined search criteria;
c) displaying search results;
d) modifying document attributes of at least one document represented by the search results to create a user defined classification; and
e) storing the user defined classification associated with the at least one document, wherein the user defined classification maintained for future searches.

19. The method for managing attributes of at least one native document according to claim 18, wherein modifying document attributes includes adding a comment to be displayed when the at least one document is later viewed.

20. The method for managing attributes of at least one native document according to claim 19, further comprising designating the comment as public so as to be displayed to users in addition to the user who authored the comment when later viewing the document.

21. The method for managing attributes of at least one native document according to claim 19, further comprising designating the comment as private so as to be displayed only to the user who authored the comment when later viewing the document.

22. The method for managing attributes of at least one native document according to claim 18, further comprising selectively sending a link to at least one document of the search results to another user.

23. The method for managing attributes of at least one native document according to claim 18, wherein modifying document attributes includes selectively categorizing the at least one document represented by the search results.

24. The method for managing attributes of at least one native document according to claim 18, wherein modifying document attributes includes selectively sending a link to the at least one document represented by the search results to a user.

25. A method for searching a plurality of native documents stored in a document management computer system, the steps comprising:
a) defining search criteria for searching the plurality of native documents;
b) executing a search in accordance with the defined search criteria;
c) displaying search results as links to data files representative of associated native documents; and
d) selectively viewing a native document represented by at least one link of the search results displayed to the user.

26. The method for searching a plurality of native documents stored in a document management computer system according to claim 25, wherein the native document is downloaded to a user interface that sent a request to selectively view the native document.

27. A method for producing search results of a plurality of native documents stored in a computer system in accordance with a user-defined search query, comprising:
a) providing at least one server in communication with the computer system for storing the plurality of native documents to be searched;
b) receiving the user-defined search query;
c) sending a search query to the computer system in accordance with the user-defined search query;
d) based on results of step (c), receiving search results from the computer system corresponding to the user-defined search query;
e) attributing at least one user defined classification to at least one document represented by the search results received in step (d), wherein the user defined classification is displayed when the at least one document is later viewed.

28. A method for producing search results of a plurality of native documents stored in a computer system in accordance with a user-defined search query comprising:
a) providing a Website hosted by a server interfacing with the computer system and a user connected via a user interface over a communication network;
b) under control of the user interface, displaying the search results of the plurality of native documents in accordance with the user-defined search query; and
c) in response to at least one user-defined classification selected by the user, attributing the user-defined classification to at least one native document represented by the search results, wherein the user-defined attribute is displayed when the link representing the at least one native document is later viewed.

29. An electronic document management system comprising:
a plurality of computer nodes for storing a plurality of native documents; and
a computer in communication with the plurality of computer nodes for receiving a plurality of input files to be uploaded to the plurality of computer nodes,
wherein the computer is configured to determine the type of native document for each of the plurality of input files, to assign a unique identification tag to each native document, and to eliminate duplicate native documents based on the unique identification tags, for producing a subset of input files to be uploaded to the plurality of computer nodes,
wherein the subset of input files are distributed substantially equally amongst the plurality of computer nodes.

30. The electronic document management system according to claim 29, wherein the computer is further configured to extract data from each native document.

31. An electronic document management system according to claim 30, wherein the computer creates a text file corresponding to the extracted data.

32. An electronic document management system according to claim 29, wherein the computer creates a data file selected from a group consisting of a text file, a meta data file, a XML file, and a HTML file.

33. An electronic document management system according to claim 29, wherein the subset of input files and associated data extracted therefrom are distributed substantially equally amongst the plurality of computer nodes.

34. An electronic document management system comprising a PC type computer connected in a parallel cluster, said computer using an operating system that stores electronic documents in a hard disk drive throughout the cluster, said operating system defining a document identification tag where each document is identified by its files extension that is converted to ASCII text and given a unique identification number, each of a plurality of documents having at least one of either meta-data, text or attachments identified for retrieval that are indexed for web-based retrieval from the cluster database, said identification of the plurality of documents forming a cluster data base that is web-searchable by use of a predetermined descriptive term.
